(19) United States
(12) Patent Application Publication
(10) Pub. No.: US 2004/0255744 A1
(43) Pub. Date: Dec. 23, 2004

(54) Cutting blade and method of making the same

(76) Inventor: Gerhard Becker, Eppstein (DE)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 10/870,787

(22) Filed: Jun. 17, 2004

(30) Foreign Application Priority Data
Jun. 18, 2003 (DE) 10327754.4

(51) Int. Cl. B26D 1/00

(52) U.S. Cl. 83/13; 83/651

(57) ABSTRACT

A cutting knife is proposed for the cutting of stacked, sheet-like material. The cutting knife has a wedge shape with one cutting surface and one repelling surface, arranged at the wedge angle to each other, and whose cutting line forms the cutting edge of the knife. According to the invention, the cutting knife is provided with outlet openings for blown air in the region of the repelling surface. In the method for fabrication of the cutting knife, channels are incorporated in the knife holder prior to connecting the knife holder and the hard metal blade of the knife, and due to the arrangement of these parts, the blown air passages are formed in the cutting knife upon connection of knife holder and hard metal blade, emerging into the outlet openings.

### BACKGROUND OF THE INVENTION

The invention concerns a cutting knife for the cutting of stacked, sheet-like material. Moreover, the invention concerns a method for the fabrication of such a cutting knife.

Cutting knives are used, in particular, to separate stacked, sheet-like material, such as a paper stack, in a drawing cut. The material rests on a flat base and the cutting knife fits into a cutting rail. A cutting surface of the knife defines a cutting plane, while the cut material is deflected in the region of a repelling surface of the knife. The material cut is either usable copies or cutting scrap.

Such devices for the cutting of stacked, sheet-like material are typically configured, for example, as a single-blade or three-blade cutting machines.

In practice, the scraps accumulating during the cutting process remain in the region of the cutting zone, which is detrimental to the further cutting sequences. One tries to dispose of the cutting scraps completely between the individual cuts, which is done manually, for example.

In DE 31 01 911 A1, the entire contents of which are hereby incorporated herein by reference, a cutting machine is specified in which the repelling surface of the cutting knife is associated with a brush mechanism. This mechanism tries to ensure that cutting scraps clinging to the knife are totally removed when the knife is lifted after making the cut. In practice, generally satisfactory results can be achieved in this way. However, it is not always possible to prevent the cut material from getting stuck in the brush.

In DE 34 44 952 A1, the entire contents of which are hereby incorporated herein by reference, a cutting machine is specified, in which a separate blown air nozzle is provided, with which air can be blown in the direction of the repelling surface of the knife. The jet of air impinges on the knife essentially parallel to the repelling surface. It is still not possible to achieve totally satisfactory results with such a device, because the blown air is oriented in the direction of the place of formation of the cutting scraps, and thus not in the direction of the actual desired direction of repelling of the scraps. Furthermore, when the cut material is brittle, there is the danger of cutting scraps being sprayed up into the region of the air nozzle and getting stuck between it and the knife. A similar device, with consequently the same drawbacks is shown in DE 37 13 897 A1, the entire contents of which are hereby incorporated herein by reference.

In DE 38 29 682 A2, the entire contents of which are hereby incorporated herein by reference, an additional blown air nozzle is provided to supplement the aforementioned one, being arranged immediately behind the cutting rail, and thus is integrated in the bench carrying the material being cut. The structural expenditure for such a device is sizeable without making a major contribution to improving the carrying away of scraps.

The drawbacks of the above-described devices are even greater when cutting material which is electrostatically charged and consequently has a tendency to stick to metal parts, such as the cutting knife. Such cutting scraps cannot be removed, or not satisfactorily removed, by the above-described blown air nozzles or brushes.

Moreover, cutting knives are known from the state of the art in which blown air is used to influence the cutting process. But these involve rotary cutting knives and devices for cutting a sheet. Refer, for example, to DE 101 08 234 A1, the entire contents of which are hereby incorporated herein by reference.

### SUMMARY OF THE INVENTION

An objective of the present invention is to create a cutting knife which ensures that cutting scraps produced during the cutting do not cling to it. This should especially be the case when the cutting knife is used to cut material having a tendency to become electrostatically charged. Moreover, an objective of the invention is to indicate a method for the fabrication of such a knife.

An objective of the invention is accomplished with a cutting knife having a repelling surface provided with outlet openings for blown air.

According to the invention, the blown air emerges from the cutting knife and consequently any cut material having a tendency to cling to the knife is blown away from the knife. This is especially advantageous in the case of cut material having a tendency to become electrostatically charged. This cut material is reliably blown away from the repelling surface of the knife.

Preferably, the blown air flows out from the cutting knife through its outlet openings. The suitable pressure level of the blown air is chosen as a function of the material being cut, such as stacked sheets of wrapping paper, plastic foil, paper, etc. Thus, the pressurized air can be air with relatively high pressure.

The conducting of the blown air through the cutting knife can occur in various ways. According to one especially structurally simple configuration, boreholes for the passage of the blown air are integrated in the cutting knife, and the boreholes emerge from the cutting knife in the region of its repelling surface. Thus, the cross section of the passage for the blown air is essentially unchanged. The boreholes can be very easily made in the cutting knife. It is quite conceivable to form nozzles in the cutting knife, for example, by having the passages for the blown air taper conically in the direction of the outlet openings or in the region of the outlet openings. According to an especially simple configuration of the knife, the boreholes or passages for the blown air are arranged in parallel with the cutting surface of the knife. It is quite conceivable to let the air emerge not parallel to the cutting surface, but perpendicular to the wedge surface.

According to an especially advantageous configuration of the cutting knife, the knife has a knife holder and a hard metal blade inserted in the latter. Both the knife holder and the hard metal blade are preferably provided with the repelling surface. In one configuration of the cutting knife with knife holder and hard metal blade, the boreholes and/or a connection channel into which the boreholes emerge are advantageously formed between the knife holder and the hard metal blade.

The supplying of blown air to the cutting knife is done, for example, by means of at least one hose, which is connected to the cutting knife at the side of the knife, in reference to a side arranged perpendicular to the cutting plane. This hose is connected to a source of pressurized air.

The cutting knife is preferably fabricated by first incorporating channels into the knife holder of the cutting knife. The channels are arranged according to the air flow in the cutting knife. After this, the knife holder is connected to the hard metal blade of the cutting knife. Due to the arrangement of the knife holder and the hard metal blade, the blown air passages are formed in the cutting knife, emerging into the outlet openings. Thus, in this case, it is not required to make boreholes in the cutting knife, but rather the channels are first produced in the knife holder, such as by milling. The channels to form the passages in the cutting knife are closed by connecting the knife holder and hard metal blade. This connection is advantageously done by soldering.

Further features of the invention are presented in the description of the figures and the figures themselves.

### BRIEF DESCRIPTION OF THE DRAWINGS

In the figures, the invention is represented by means of a sample embodiment, without being limited to this. It shows:

FIG. 1 is a front view of the invented cutting knife, looking in the direction of one major surface, assigned to the repelling surface of the cutting knife (view B of FIG. 2); and

FIG. 2 is a cross section through the cutting knife along line A-A in FIG. 1, illustrated in magnified presentation.

### DETAILED DESCRIPTION OF PREFERRED EMBODIMENT

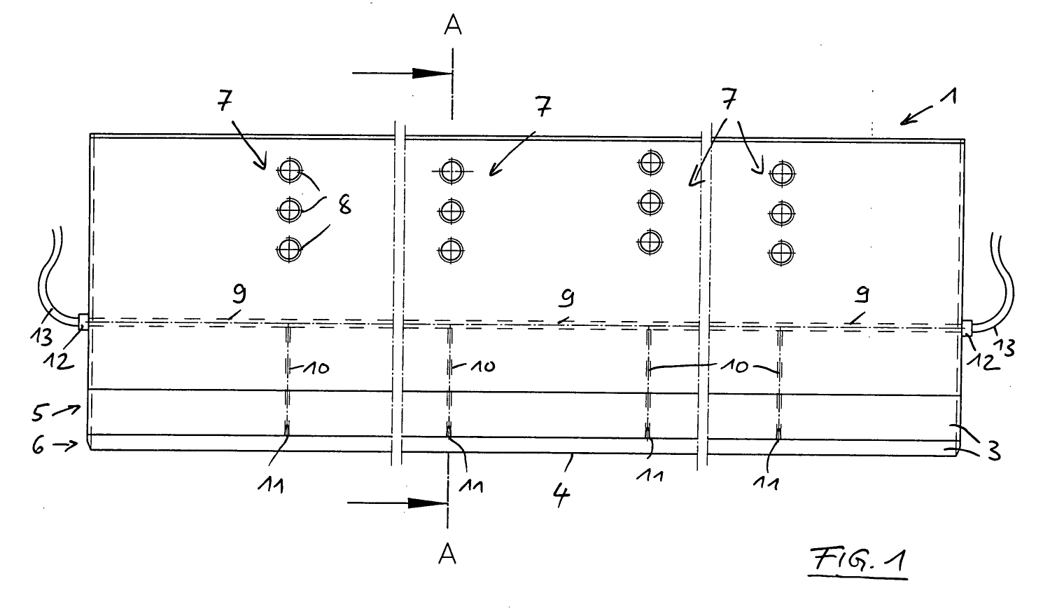

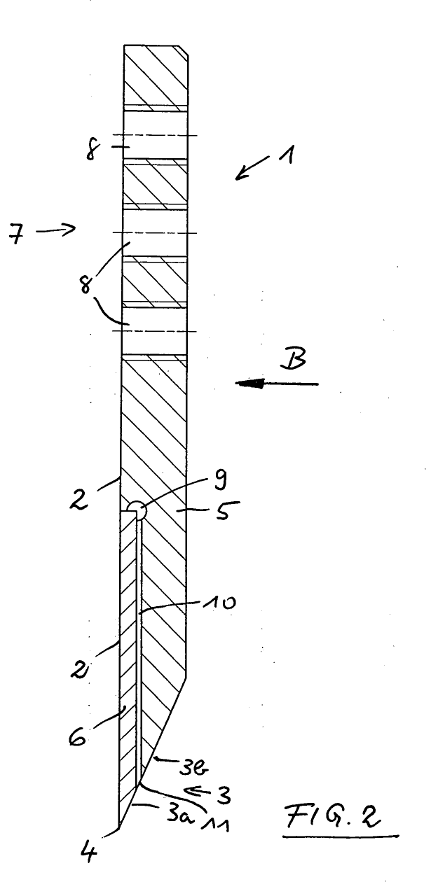

The cutting knife shown in FIGS. 1 and 2 is used, for example, in a cutting machine, as is disclosed in DE 31 01 911 A1 or DE 37 13 897 A1.

The cutting knife 1 for cutting of stacked, sheet-like material has a wedge shape. It has a cutting surface 2 and a repelling surface 3. These are arranged at a wedge angle to each other. Their cutting line forms the cutting edge 4 of the knife 1.

The knife 1 consists of a knife holder 5, which is provided with a recess to accommodate a hard metal blade 6. The hard metal blade 6 is positioned relative to the knife holder 5 so that the repelling surface segments 3a and 3b form the flat repelling surface 3. In the upper region, the cutting knife has various hole arrangements 7, arranged next to each other, each hole arrangement 7 being formed by three threaded boreholes 8 one above the other. These serve to fasten the cutting knife 1, or specifically the knife holder 5, to the knife beam of a cutting machine (not shown), by means of screws. The boreholes 8 arranged one above the other are therefore intended to balance out the reduced height of the cutting knife 1 as a result of its resharpening.

The cutting knife 1 has an air channel 9 passing through it, parallel with the cutting edge 4, and a number of additional air channels 10 which branch off perpendicularly from it, whose outlet openings 11 are located in the region of the repelling surface 3.

The air channels 9 and 10 are made by milling grooves in the knife holder 5 in the region of its recess prior to soldering the hard metal blade 6 to the knife holder 5. The hard metal blade 6 is then inserted into this recess of the knife holder 5 and soldered together with the knife holder 5. When the hard metal blade 6 is placed on the knife holder 5 the grooves are closed, thereby forming the air channels 9 and 10. On opposite sides of the cutting knife 1, i.e., in the region of the outlet openings of the air channel 9, connectors 12 for connecting hoses 13 are secured to the cutting knife 1. Pressurized air is supplied through these to the air channels 9 and 10. Preferably, the supply of pressurized air is timed so that it is supplied when the cutting knife is descending, i.e., cutting, and when the cutting knife is retracting.

Instead of supplying the pressurized air by means of a hose to the cutting knife, a connection can be provided between the knife beam and the knife holder through which the pressurized air can be taken. When fastening the knife holder to the beam, air boreholes in the beam and in the knife holder are connected. Coupling elements are provided accordingly on the knife beam or knife holder, which interact when the knife holder is connected to the knife beam and provide a fluid-tight connection between these parts. The replacement of the cutting knife can then take place as usual, and the connecting of the air connectors is done automatically.

The above description is considered that of the preferred embodiment only. Modifications of the invention will occur to those skilled in the art and to those who make or use the invention. Therefore, it is understood that the embodiment shown in the drawings and described above is merely for illustrative purposes and not intended to limit the scope of the invention, which is defined by the following claims as interpreted according to the principles of patent law, including the doctrine of equivalents.

The invention claimed is:

1. A cutting knife for cutting of stacked, sheet-like material, wherein the cutting knife has a wedge shape with a cutting surface and a repelling surface for repelling the cut material, the cutting surface and the repelling surface being arranged at a wedge angle to each other and whose cutting line forms a cutting edge of the knife, characterized in that the knife is provided with outlet openings for blown air in a region of the repelling surface.

2. The cutting knife of claim 1, characterized in that boreholes or channels for blown air are integrated in the cutting knife and the boreholes or channels emerge from the knife in the region of the repelling surface.

3. The cutting knife of claim 2, characterized in that the boreholes or channels can be connected to a pressurized air supply.

4. The cutting knife of claim 3, characterized in that the boreholes or channels emerge into a connection channel which can be connected to a pressurized air supply.

5. The cutting knife of claim 2, wherein the cutting knife comprises a knife holder and a hard metal blade inserted into the knife holder.

6. The cutting knife of claim 5, characterized in that the boreholes or channels are formed between the knife holder and the hard metal blade.

7. The cutting knife of claim 5, characterized in that the hard metal blade and the knife holder are joined together by means of a solder connection.

8. The cutting knife of claim 1, characterized in that at least one hose is provided to supply the blown air, which is connected laterally to the knife in relation to the side arranged perpendicularly to the cutting surface.

9. The cutting knife of claim 2, characterized in that the boreholes or channels are arranged parallel to the cutting surface.

10. A method for making a cutting knife with the features of claim 1, comprising:
incorporating channels in a knife holder of the cutting knife; and
connecting the knife holder and a hard metal blade of the knife, wherein, due to the arrangement of knife holder and hard metal blade, blown air passages are formed in the cutting knife and emerge into the outlet openings.

11. The method of claim 10, wherein the hard metal blade and the knife holder are joined together by soldering.

12. A cutting apparatus for cutting of stacked, sheet like material comprising:
a knife having a wedge shape;
the knife including a cutting surface and a repelling surface for repelling the cut material;
the cutting surface and the repelling surface being arranged at a wedge angle; and
the cutting surface and the repelling surface having a cutting line forming a cutting edge of the knife;
wherein the knife includes outlet openings in the repelling surface for blowing air in a region of the repelling surface.

13. The cutting apparatus of claim 12, further including:
holes for blown air integrated into the knife;
wherein the holes are connected to the outlet openings.

14. The cutting apparatus of claim 13, wherein:
the holes can be connected to a pressurized air supply.

15. The cutting apparatus of claim 14, wherein:
the holes emerge into a connection channel, which can be connected to a pressurized air supply.

16. The cutting apparatus of claim 13, wherein:
the knife comprises a knife holder and a blade inserted into the knife holder.

17. The cutting apparatus of claim 16, wherein:
the holes are formed between the knife holder and the blade.

18. The cutting apparatus of claim 16, wherein:
the blade and the knife holder are joined together by means of a solder connection.

19. The cutting apparatus of claim 12, further including:
at least one hose is provided to supply the blown air, the at least one hose being connected laterally to the knife in relation to a side arranged perpendicularly to the cutting surface.

20. The cutting apparatus of claim 13, wherein:
the holes are arranged parallel to the cutting surface.

21. A method for making the cutting apparatus of claim 12 comprising:
incorporating channels in a knife holder of the knife; and
connecting the knife holder and a blade of the knife;
wherein, due to the arrangement of the knife holder and the blade, blown air passages are formed in the knife and emerge into the outlet openings.

22. The method of claim 21, further including:
soldering the blade and the knife holder together.
